(19) United States
(12) Patent Application Publication
(10) Pub. No.: US 2025/0075284 A1
(43) Pub. Date: Mar. 6, 2025

(54) NON-ORIENTED ELECTRICAL STEEL SHEET AND METHOD FOR MANUFACTURING SAME

(71) Applicant: POSCO CO., LTD, Gyeongsangbuk-do, Pohang-si (KR)

(72) Inventor: Soobin Kwon, Pohang-si, Gyeongsangbuk-do (KR)

(73) Assignee: POSCO CO., LTD, Gyeongsangbuk-do, Pohang-si (KR)

(21) Appl. No.: 18/722,335

(22) PCT Filed: Dec. 21, 2022
(86) PCT No.: PCT/KR2022/020962

§ 371 Date: Jun. 20, 2024

(30) Foreign Application Priority Data
Dec. 22, 2021 (KR) 10-2021-0184701

(51) Int. Cl. C21D 9/46; C21D 6/00; C21D 8/12; C22C 38/00; C22C 38/02; C22C 38/04; C22C 38/06; C22C 38/24; C22C 38/26; C22C 38/28; C22C 38/34; C22C 38/38; C22C 38/60; H01F 1/147

(52) U.S. Cl. CPC C21D 9/46; C21D 6/002; C21D 6/005; C21D 6/008; C21D 8/1222; C21D 8/1233; C21D 8/1261; C21D 8/1277; C22C 38/001; C22C 38/002; C22C 38/004; C22C 38/008; C22C 38/02; C22C 38/04; C22C 38/06; C22C 38/24; C22C 38/26; C22C 38/28; C22C 38/34; C22C 38/38; C22C 38/60; H01F 1/14791

(57) ABSTRACT

A non-oriented electrical steel sheet according to one embodiment of the present invention comprises, in wt %, 2.0 to 6.5% of Si, 0.1 to 1.3% of Al, 0.3 to 2.0% of Mn, and the remainder in Fe and unavoidable impurities, and the area fraction of grains the diameters of which are at most 10% of the sheet thickness is 10.0 to 35.0%, while the number fraction is 15 to 55%.

### TECHNICAL FIELD

An embodiment of the present disclosure relates to a non-oriented electrical steel sheet and a method for manufacturing the same. Specifically, an embodiment of the present disclosure relates to a non-oriented electrical steel sheet which has increased strength in a rolling direction and a rolling vertical direction by increasing a shot ball projection amount to increase energy accumulated on the surface when removing scale, and a method for manufacturing the same.

### BACKGROUND ART

A non-oriented electrical steel sheet is mainly used in a motor which converts electrical energy into mechanical energy, and in order to exhibit high efficiency in this process, the non-oriented electrical steel sheet is required to have excellent magnetic properties. In particular, in recent years, as environmentally-friendly technology has been gaining attention, it is considered to be very important to increase the efficiency of motors, which accounts for more than a half of total electrical energy consumption, and to this end, the demand for a non-oriented electrical steel sheet having excellent magnetic properties is also increasing.

The magnetic properties of the non-oriented electrical steel sheet is mainly evaluated by iron loss and magnetic flux density. Iron loss refers to energy loss occurring at certain magnetic flux density and frequency, and magnetic flux density refers to a magnetization degree obtained under the certain magnetic field. As the iron loss is lower, a motor having higher energy efficiency may be manufactured under the same conditions, and as the magnetic flux density is higher, the motor may be miniaturized or copper loss may be decreased. Thus, it is important to manufacture a non-oriented electrical steel sheet having low iron loss and high magnetic flux density.

The characteristics of the non-oriented electrical steel sheet to be considered also vary depending on the operation conditions of the motor. As a criterion for evaluating the characteristics of the non-oriented electrical steel sheet to be used in the motor, W15/50 which is iron loss when a 1.5 T magnetic field is applied to a plurality of motors at a commercial frequency of 50 Hz is considered to be the most important. However, the W15/50 iron loss is not considered to be the most important in all motors of various uses, and iron loss at another frequency or applied magnetic field is also evaluated depending on main operation conditions. In particular, in the non-oriented electrical steel sheet used in a drive motor of the recent electric vehicles, since magnetic properties are often important at a low magnetic field of 1.0 T or less and a high frequency of 400 Hz or more, the characteristics of the non-oriented electrical steel sheet are evaluated by iron loss such as W10/400.

In addition, a motor core may be divided into a stator core and a rotor core, and in order to meet the recent demands for miniaturization/high output of a HEV drive motor and the like, a non-oriented electrical steel sheet used in the stator core strongly requires high magnetic flux density and low iron loss for excellent magnetic properties.

In addition, as a means of achieving miniaturization/high output of the HEV drive motor and the like, the rotation speed of the motor tends to increase, but since the HEV drive motor has a large outer diameter, considering that a large centrifugal force acts on the rotor core and a very narrow portion (1-2 mm) referred to as a rotor core bridge portion exists depending on its structure, a non-oriented electrical steel sheet used in the rotor core requires to have higher strength than before.

Therefore, as the characteristics of the non-oriented electrical steel sheet used in the motor core, not only excellent magnetic properties but also high strength for a rotor core and high magnetic flux density/low iron loss for a stator core is ideal. As such, even in the case of the non-oriented electrical steel sheet used in the motor core, the characteristics required for the rotor core and those for the stator core are greatly different from each other, but in the manufacture of the motor core, in terms of increasing a material yield, it is preferred that a rotor core material and a stator core material are collected at the same time from the same material steel sheet, and then each core material is laminated to assemble the rotor core and the stator core.

### DISCLOSURE

### Technical Problem

The present disclosure attempts to provide a non-oriented electrical steel sheet and a method for manufacturing the same. Specifically, the present disclosure attempts to provide a non-oriented electrical steel sheet which has increased yield strength in all directions of the electrical steel sheet by increasing a shot ball projection amount during removal of scale to increase nuclear production sites of the electrical steel sheet and securing microcrystal grains after annealing a cold rolled sheet, and a method for manufacturing the same.

### Technical Solution

An exemplary embodiment of the present disclosure provides a non-oriented electrical steel sheet including, by weight: 2.0 to 6.5% of Si, 0.1 to 1.3% of Al, and 0.3 to 2.0% of Mn, with a remainder of Fe and unavoidable impurities, wherein crystal grains having a particle diameter of 10% or less of a sheet thickness has an area fraction of 10.0% to 35.0% and a number fraction of 15% to 55%.

The non-oriented electrical steel sheet according to an exemplary embodiment of the present disclosure may further include one or more of 0.2 wt % or less (excluding 0%) of Cr, 0.06 wt % or less (excluding 0%) of Sn, and 0.06 wt % or less (excluding 0%) of Sb.

The non-oriented electrical steel sheet according to an exemplary embodiment of the present disclosure may further include 0.005 wt % or less of one or more of C, N, S, Ti, Nb, and V.

The non-oriented electrical steel sheet according to an exemplary embodiment of the present disclosure may further include one or more of 0.01 to 0.2 wt % of Cu, 0.100 wt % or less of P, 0.002 wt % or less of B, 0.01 wt % or less of Mo, 0.005 wt % or less of Mg, and 0.005 wt % or less of Zr.

The non-oriented electrical steel sheet according to an exemplary embodiment of the present disclosure may have an average crystal grain particle diameter of 5 to 50 μm.

The non-oriented electrical steel sheet according to an exemplary embodiment of the present disclosure may have a yield strength measured in a rolling direction and a yield strength measured in a rolling vertical direction which satisfy the following Equation 1 and Equation 2:

$$( Y {P}_{0.2 R} + Y {P}_{0.2 C} ) / 2 \geq 480 \qquad [ Equation 1 ]$$

$$\vert {YP}_{0.2 R} - Y {P}_{0.2 C} \vert / \{ ( {YP}_{0.2 R} + Y {P}_{0.2 C} ) / 2 \} \leq 0.025 \qquad [ Equation 2 ]$$

wherein YP_{0.2R} is a yield strength (MPa) measured in a rolling direction, and YP_{0.2C} is a yield strength (MPa) measured in a rolling vertical direction. Iron loss (W_{10/1000}) may satisfy the following Equation 3:

$${W}_{10 / 1000} \leq 40 + t \times 240 \qquad [ Equation 3 ]$$

wherein W_{10/1000} is iron loss (W/kg) when a magnetic flux density of 1.0 T is induced with a frequency of 1000 Hz, and t is a thickness (mm) of the steel sheet.

The non-oriented electrical steel sheet according to an exemplary embodiment of the present disclosure may have a thickness of 0.10 to 0.30 mm.

Another exemplary embodiment of the present disclosure provides a method for manufacturing a non-oriented electrical steel sheet including: hot rolling a slab including, by weight: 2.0 to 6.5% of Si, 0.1 to 1.3% of Al, and 0.3 to 2.0% of Mn, with a remainder of Fe and unavoidable impurities, thereby manufacturing a hot rolled sheet; removing scale present on a surface of the hot rolled sheet; cold rolling the descaled hot rolled steel sheet to manufacture a cold rolled sheet; and annealing the cold rolled sheet, wherein the removing of scale is performed by projecting shot balls in an amount of 15 kg/(min·m²) to 35 kg/(min·m²) onto the steel sheet.

A material of the shot balls may be a Fe-based alloy.

The annealing of the cold rolled sheet may be performed at a temperature of 700 to 850° C.

Annealing of the hot rolled sheet may be further included before the removing of scale.

### Advantageous Effects

According to an exemplary embodiment of the present disclosure, micro-recrystallization may be formed in a large amount, by increasing a shot ball projection amount during scale removal. Thus, yield strength in all directions including a rolling direction (RD direction) and a rolling vertical direction (TD direction) is improved.

Thus, performance of motors for environmentally-friendly cars, motors for high-efficiency appliances, and super premium grade motors may be further improved.

### Mode for Invention

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

In the present specification, when it is mentioned that a part is “on” or “above” the other part, it means that the part is directly on or above the other part or another part may be interposed therebetween. In contrast, when it is mentioned that a part is “directly on” the other part, it means that nothing is interposed therebetween.

In addition, unless otherwise particularly described, % refers to wt %, and 1 ppm refers to 0.0001 wt %.

In an exemplary embodiment of the present disclosure, the meaning of further inclusion of an additional element is replacing iron (Fe) as a remainder by the addition amount.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

Hereinafter, an exemplary embodiment of the present disclosure will be described in detail so that a person with ordinary skill in the art to which the present disclosure pertains may easily carry out the present disclosure. As those skilled in the art would realize, the described embodiments may be modified in various different ways, all without departing from the spirit or scope of the present disclosure.

A non-oriented electrical steel sheet according to an exemplary embodiment of the present disclosure includes, by weight: 2.0 to 6.5% of Si, 0.1 to 1.3% of Al, and 0.3 to 2.0% of Mn, with a remainder of Fe and unavoidable impurities.

Hereinafter, the reason for limiting steel sheet alloy components will be described first.

Si: 2.0 to 6.5 wt %

Silicon (Si) serves to lower iron loss by increasing the resistivity of a material, and if it is added too little, a high-frequency iron loss improvement effect may be insufficient. On the contrary, if it is added too much, hardness of a material is increased to extremely deteriorate cold rolling properties, so that productivity and blanking properties may become poor. Therefore, Si may be added in the range described above. More specifically, it may be included at 2.5 to 5.0 wt %. More specifically, it may be included at 3.0 to 4.0 wt %.

Al: 0.1 to 1.3 wt %

Aluminum (Al) serves to lower iron loss by increasing the resistivity of a material. When it is added too little, it is not effective in reducing high-frequency iron loss and a nitride may be finely formed to deteriorate magnetism. On the contrary, when it is added too much, problems are caused in all processes such as steel making and continuous casting, thereby greatly reducing productivity. Therefore, Al may be added in the range described above. More specifically, it may be included at 0.5 to 1.2 wt %. More specifically, it may be included at 0.7 to 1.0 wt %.

Mn: 0.3 to 2.0 wt %

Manganese (Mn) is an element which serves to improve iron loss by increasing the resistivity of a material and form a sulfide. When Mn is added too little, a sulfide may be finely precipitated to deteriorate magnetism. On the contrary, when Mn is added too much, formation of {111} texture which is unfavorable to magnetism may be promoted so that magnetic flux density may be decreased. Thus, Mn may be added in the range described above. More specifically, Mn may be included at 0.5 to 1.5 wt %.

In an exemplary embodiment of the present disclosure, resistivity may be 55 to 80 μΩ·cm.

The non-oriented electrical steel sheet according to an exemplary embodiment of the present disclosure may further include one or more 0.2% or less (excluding 0%) of Cr, 0.06% or less (excluding 0%) of Sn, and 0.06% or less (excluding 0%) of Sb.

Cr: 0.20 wt % or less

Chromium (Cr) serves to decrease iron loss by increasing the resistivity of a material. Therefore, Cr may be added in the range described above. More specifically, Cr may be included at 0.010 to 0.10 wt %. More specifically, Cr may be included at 0.050 to 0.040 wt %. As described above, when an additional element is further included, it replaces Fe as a remainder.

Sn: 0.06 wt % or less and Sb: 0.06 wt % or less

Tin (Sn) and antimony (Sb) are added to a crystal grain boundary as segregation elements for suppressing diffusion of nitrogen through the crystal grain boundary, suppressing {111} texture which is unfavorable to magnetism, and increasing favorable {100} texture to improve magnetic properties. When Sn and Sb are added too much, respectively, crystal grain growth is hindered to deteriorate magnetism and rolling properties. Therefore, Sn and Sb may be added in the range described above. More specifically, 0.005 to 0.050 wt % of Sn and 0.005 to 0.050 wt % of Sb may be included. More specifically, 0.01 to 0.02 wt % of Sn and 0.01 to 0.02 wt % of Sb may be included.

A steel sheet base material may further include one or more of 0.01 to 0.2 wt % of Cu, 0.100 wt % or less of P, 0.002 wt % or less of B, 0.01 wt % or less of Mo, 0.005 wt % or less of Mg, and 0.005 wt % or less of Zr. Cu: 0.01 to 0.20 wt %

Copper (Cu) serves to form a sulfide with Mn. When Cu is further added, if it is added too little, CuMnS may be finely precipitated to deteriorate magnetism. If Cu is added too much, high temperature brittleness may occur to form cracks during soft casting or hot rolling. More specifically, Cu may be included at 0.05 to 0.10 wt %.

P: 0.100 wt % or less

Since phosphorus (P) serves to increase the resistivity of a material and also is segregated in a grain boundary to improve texture to increase the resistivity and lower iron loss, it may be further added. However, when the amount of P added is too much, formation of texture which is unfavorable to magnetism is caused so that there is no effect of texture improvement, and P is excessively segregated in the grain boundary to deteriorate rollability and workability, which makes production difficult. Therefore, P may be added in the range described above. More specifically, P may be included at 0.001 to 0.090 wt %. More specifically, P may be included at 0.005 to 0.085 wt %.

B: 0.002 wt % or less, Mo: 0.01 wt % or less, Mg: 0.005 wt % or less, and Zr: 0.005 wt % or less

Since boron (B), molybdenum (Mo), magnesium (Mg), and zirconium (Zr) react with impurity elements to form fine sulfides, carbides, and nitrides and have an adverse effect on magnetism, their contents may be limited as described above.

The steel sheet base material may further include one or more of C, N, S, Ti, Nb, and V at 0.005 wt % or less.

C: 0.005 wt % or less

Carbon (C), when added much, expands an austenite region to increase a phase transformation section, suppresses crystal grain growth of ferrite during annealing to increase iron loss, is bonded to Ti and the like to form a carbide to deteriorate magnetism, and when processed into an electrical product as a final product and then used, increases iron loss by magnetic aging. Therefore, C may be added in the range described above. More specifically, C may be included at 0.003 wt % or less.

S: 0.005 wt % or less

Since sulfur(S) forms a fine sulfide inside the base material to suppress crystal grain growth, thereby weakening iron loss, it is preferred to add sulfur as little as possible. When S is included in a large amount, it is bonded to Mn and the like to form a precipitate or cause high temperature brittleness during hot rolling. Therefore, S may be further included at 0.005 wt % or less. Specifically, S may be further included at 0.0030 wt % or less. More specifically, S may be further included at 0.0001 to 0.0030 wt %.

N: 0.005 wt % or less

Nitrogen (N) is strongly bonded to Al, Ti, and the like to form a nitride and suppress crystal grain growth, and since it hinders movement of a magnetic domain when precipitated, it is preferred to contain less N. Therefore, N may be added in the range described above. More specifically, N may be included at 0.003 wt % or less.

Ti, Nb, V: 0.005 wt % or less

Since titanium (Ti), niobium (Nb), vanadium (V) and the like are also strong carbide forming elements, it is preferred not to add them if possible, and they are included at 0.01 wt % or less, respectively.

The remainder includes Fe and unavoidable impurities. Since unavoidable impurities are impurities incorporated in a manufacturing process of a steel making step and a manufacturing process of the electrical steel sheet and are known in the art, detailed description will be omitted. Addition of elements other than the alloy component described above in an exemplary embodiment of the present disclosure is not excluded, and various elements may be included within a range which does not impair the technical idea of the present disclosure. When the additional element is further included, it replaces Fe as the remainder.

The steel sheet according to an exemplary embodiment of the present disclosure secures fine grain crystals in the steel sheet to improve mechanical strength and also appropriately secure magnetism. Specifically, crystal grains having a particle diameter of 10% or less of a sheet thickness may have an area fraction of 10.0% to 35.0% and a number fraction of 15% to 55%. Crystal grains having a particle diameter of 10% or less of a sheet thickness help to improve mechanical strength. Meanwhile, when only the area fraction or only the number fraction of the microcrystal grains is secured, a problem may arise in terms of workability. More specifically, the crystal grains having a particle diameter of 10% or less of the sheet thickness may have the area fraction of 15% to 35% and the number fraction of 15% to 55%. In an exemplary embodiment of the present disclosure, the particle diameter and the area/number fraction of the crystal grains may be measured based on a surface parallel to a rolling surface (ND surface) of the steel sheet. Though the particle diameter and the area/number fraction of the crystal grains are not changed depending on the position of measured thickness, a specific measurement thickness position may be a ½ position of the steel sheet thickness. When an imaginary circle having the same area as the crystal grains is assumed, the diameter of the circle is regarded as the particle diameter of the crystal grains. The lower limit of the micro-recrystallization particle diameter is not particularly limited, but may be 0.1 μm which is a measurement limit.

The non-oriented electrical steel sheet according to an exemplary embodiment of the present disclosure may have an average crystal grain particle diameter of 5 to 50 μm. When the average crystal grain particle diameter is too small, non-oriented electrical steel sheet is poor in terms of magnetism and has poor workability. When the average crystal grain particle diameter is too large, non-oriented electrical steel sheet may be poor in terms of mechanical strength. More specifically, the average crystal grain particle diameter may be 10 to 40 μm. As a method of adjusting the crystal grain particle diameter, a shot ball projection amount is increased during scale removal of the hot rolled sheet to increase nucleation sites during recrystallization, thereby securing the micro-recrystallization fraction. Since this will be described in detail in the method for manufacturing a non-oriented electrical steel sheet described later, redundant description will be omitted.

A yield strength measured in a rolling direction and a yield strength measured in a rolling vertical direction of the non-oriented electrical steel sheet according to an exemplary embodiment of the present disclosure may satisfy the following Equation 1 and Equation 2:

$$( Y {P}_{0.2 R} + Y {P}_{0.2 C} ) / 2 \geq 480 \qquad [ Equation 1 ]$$

$$\vert {YP}_{0.2 R} - Y {P}_{0.2 C} \vert / \{ ( {YP}_{0.2 R} + Y {P}_{0.2 C} ) / 2 \} \leq 0.025 \qquad [ Equation 2 ]$$

wherein YP_{0.2R} is a yield strength (MPa) measured in a rolling direction, and YP_{0.2C} is a yield strength (MPa) measured in a rolling vertical direction.

The meaning of satisfying Equations 1 and 2 is that both yield strengths measured in the rolling direction and the rolling vertical direction are excellent, and this is useful since rotor strength may be secured when an iron core, in particular, a rotor of the motor is manufactured using the non-oriented electrical steel sheet.

Iron loss (W_{10/1000}) of the non-oriented electrical steel sheet according to an exemplary embodiment of the present disclosure may satisfy the following Equation 3:

$${W}_{10 / 1000} \leq 40 + t \times 240 \qquad [ Equation 3 ]$$

wherein W_{10/1000} is iron loss (W/kg) when a magnetic flux density of 1.0 T is induced with a frequency of 1000 Hz, and t is a thickness (mm) of the steel sheet.

More specifically, the following equation may be satisfied:

$${W}_{10 / 1000} \leq 30 + t \times 150$$

Herein, the iron loss may be an average value of iron loss measured in the rolling direction (RD direction) and the rolling vertical direction (TD direction). More specifically, the iron loss (W_{10/1000}) may be 55 to 70 W/kg.

The non-oriented electrical steel sheet according to an exemplary embodiment of the present disclosure may have a thickness of 0.10 to 0.30 mm.

A method for manufacturing a non-oriented electrical steel sheet according to an exemplary embodiment of the present disclosure includes: hot rolling a slab to manufacture a hot rolled sheet; removing scale present on a surface of the hot rolled sheet; cold rolling the descaled hot rolled sheet to manufacture a cold rolled sheet; and annealing the cold rolled sheet.

First, a slab is hot rolled.

Since the alloy components of the slab are as described in the alloy components of the non-oriented electrical steel sheet, redundant description will be omitted. Since the alloy components are not substantially changed in the manufacturing process of the non-oriented electrical steel sheet, the alloy components of the non-oriented electrical steel sheet and those of the slab are substantially the same.

Specifically, the slab includes, by weight: 2.0 to 6.5% of Si, 0.1 to 1.3% of Al, and 0.3 to 2.0% of Mn, with a remainder of Fe and unavoidable impurities.

Since other additional elements are described in the alloy components of the non-oriented electrical steel sheet, redundant description will be omitted.

The slab may be heated before hot rolling. Though the heating temperature of the slab is not limited, the slab may be heated to 1100 to 1250° C. When the slab heating temperature is too high, precipitates which harm magnetism may be dissolved again and finely precipitated after the hot rolling.

Next, the slab is hot rolled to manufacture a hot rolled sheet. The hot rolled sheet may have a thickness of 2 to 3.0 mm.

After the manufacturing of the hot rolled sheet, annealing of the hot rolled sheet may be further included. It is preferred to perform the hot rolled sheet annealing in manufacturing a high grade electrical steel sheet having no phase transformation, and the hot rolled sheet annealing is effective for improving magnetic flux density by improving the texture of a final annealed sheet.

Herein, the annealing of the hot rolled sheet may be performed at a temperature of 850 to 1200° C. When the hot rolled sheet annealing temperature is too low, the texture does not grow or finely grows, so that it is difficult to expect an effect of increasing magnetic flux density. When the hot rolled sheet annealing temperature is too high, the magnetic properties are rather deteriorated, and rolling workability may become poor due to the deformation of a plate shape. The hot rolled sheet annealing is performed for increasing orientation favorable to magnetism, if necessary, and may be omitted. The annealed hot rolled sheet may be pickled.

Next, scale present on the surface of the hot rolled sheet surface is removed. In an exemplary embodiment of the present disclosure, scale is removed using shot ball blasting, and the fraction of micro-recrystallization may be secured due to an increase in nucleation sites during recrystallization, by increasing a shot ball projection amount.

The removing of scale includes removing scale by projection shot balls in an amount of 15 to 35 kg/(min·m²) onto the steel sheet. When the shot ball projection amount is too small, nucleation sites are not sufficiently secured and it is difficult to sufficiently secure micro-recrystallization. On the contrary, when the shot ball projection amount is too large, a steel sheet surface is much damaged, and thus, the upper limit may be appropriately adjusted. More specifically, the shot balls may be projected in an amount of 17 to 30 kg/(min·m²) onto the steel sheet. Even when the same amount per area is projected, there is a difference in securing microcrystal grains depending on the length of projection time, and thus, the projection amount depending on time and area is defined in an exemplary embodiment of the present disclosure.

The shot balls may have an average particle size of 0.1 to 1 mm and may be projected for 1 to 60 seconds. More specifically, the shot balls may have an average particle size of 0.3 to 0.8 mm and may be projected for 5 to 30 seconds. The average particle size and the projection time of the shot balls may also affect nucleation sites on the surface.

Though the material of the shot balls is not limited, a Fe-based alloy may be used.

After the shot ball projection, the surface of the steel sheet having an increased projection amount may be made smooth by immersing the steel sheet in a pickling solution. The pickling solution is not particularly limited, and a hydrochloric acid may be used. When the concentration or the immersion time of the pickling solution is too low or short, the roughness of the steel sheet having an increased projection amount is increased, resulting in a problem on a surface. On the contrary, when the concentration or the immersion time of the pickling solution is too high or long, the surface of the steel sheet may be damaged much. More specifically, the pickling may be performed by immersion in a pickling solution for 10 to 60 seconds.

Next, the hot rolled sheet is cold rolled to manufacture a cold rolled sheet. The cold rolling is final rolling to a thickness of 0.15 mm to 0.65 mm. If necessary, second cold rolling may be performed after the first cold rolling and intermediate annealing, and a final reduction rate may be in a range of 50 to 95%.

Next, the cold rolled sheet is annealed. Cold rolled sheet annealing is performed in a range of 700 to 850° C. for 10 to 1000 seconds so that the crystal grain size on the steel sheet cross section is 5 to 50 μm. When the cold rolled sheet annealing temperature is too low, crystal grains are small, so that iron loss may be deteriorated. When the temperature is too high, crystal grains are coarsened, and mechanical strength may be decreased. More specifically, the annealing may be performed in a range of 740 to 820° C.

After the annealing of the cold rolled sheet, 80% by area or more of the texture worked by the cold rolling of the steel sheet may be recrystallized. Next, the insulating coating film may be formed after the annealing of the cold rolled sheet. The insulating coating film may be treated with organic, inorganic, and organic and inorganic composite coating films, and may also be treated with other coating agent capable of insulation. For example, it may be formed by applying an insulating coating film forming composition including 40 to 70 wt % of a metal phosphate and 0.5 to 10 wt % of silica.

Hereinafter, the present disclosure will be described in more detail by the examples. However, the examples are only for illustrating the present disclosure, and the present disclosure is not limited thereto.

### EXAMPLES

Slabs including the components of the following Table 1 and Table 2 with a remainder of Fe and other unavoidable impurities were manufactured. The slabs were heated to 1150° C. and hot finish rolled at 850° C. to manufacture hot rolled sheets having a sheet thickness of 2.3 mm. The hot rolled sheets were annealed at 1100° C. for 4 minutes. Next, steel shot balls having an average diameter of 0.5 μm were blasted with the projection amount and time summarized in the following Table 3 to remove scale, and then pickling was performed. Thereafter, cold rolling was performed to make the sheet thickness 0.27 mm, and the cold rolled sheets were annealed at 800° C. for 5 minutes.

At this time, each component content was measured by an ICP wet analysis method.

As the average diameter of the crystal grains, and the area fraction and the number fraction of fine grains, the average, the average fraction, and the number fraction values obtained when a merge was performed by a merge function of OIM software and calculation was performed by a grain size (diameter) function, after polishing a TD cross section of a specimen and performing measurement with EBSD to have an area of 100 mm² or more were used.

A yield strength was tested in accordance with the standards of ISO 6892-1,2. The magnetic properties such as iron loss were measured by cutting each specimen into width 60 mm×length 60 mm×5 sheets, and performing measurement in a rolling direction and a rolling vertical direction with a single sheet tester.

TABLE 1

| (wt %) | Si | Al | Mn | Cr | Sn | Sb |
|---|---|---|---|---|---|---|
| 1 | 3.2 | 1.1 | 0.6 | 0.015 | 0.01 | 0.05 |
| 2 | 3.7 | 0.9 | 0.9 | 0.020 | 0.01 | 0.04 |
| 3 | 3.2 | 0.7 | 1.2 | 0.025 | 0.02 | 0.06 |
| 4 | 4.0 | 0.3 | 1.8 | 0.035 | 0.02 | 0.04 |
| 5 | 2.9 | 1.0 | 2 | 0.040 | 0.03 | 0.03 |
| 6 | 3.0 | 1.2 | 1.7 | 0.045 | 0.03 | 0.02 |
| 7 | 3.8 | 1.0 | 1.4 | 0.500 | 0.03 | 0.01 |
| 8 | 4.0 | 0.8 | 1.1 | 0.055 | 0.06 | 0.03 |
| 9 | 1.8 | 1.3 | 0.3 | 0.010 | 0.01 | 0.06 |
| 10 | 6.7 | 0.4 | 0.5 | 0.055 | 0.06 | 0.01 |
| 11 | 2.1 | 0.08 | 1.5 | 0.030 | 0.02 | 0.05 |
| 12 | 1.7 | 1.5 | 1.8 | 0.035 | 0.02 | 0.04 |
| 13 | 3.2 | 0.6 | 0.2 | 0.035 | 0.02 | 0.04 |
| 14 | 3.8 | 0.9 | 2.3 | 0.025 | 0.02 | 0.06 |
| 15 | 2.5 | 0.9 | 0.9 | 0.020 | 0.01 | 0.04 |
| 16 | 3.0 | 0.7 | 1.2 | 0.025 | 0.02 | 0.06 |
| 17 | 3.5 | 0.5 | 1.5 | 0.030 | 0.02 | 0.05 |
| 18 | 3.2 | 1.2 | 1.7 | 0.045 | 0.03 | 0.02 |
| 19 | 2.8 | 1.0 | 1.4 | 0.500 | 0.03 | 0.01 |

TABLE 2

| (wt %) | C | N | S | Ti | Nb | V |
|---|---|---|---|---|---|---|
| 1 | 0.002 | 0.003 | 0.001 | 0.004 | 0.001 | 0.005 |
| 2 | 0.003 | 0.001 | 0.003 | 0.003 | 0.005 | 0.003 |
| 3 | 0.001 | 0.005 | 0.003 | 0.003 | 0.005 | 0.003 |
| 4 | 0.003 | 0.001 | 0.005 | 0.002 | 0.003 | 0.002 |
| 5 | 0.004 | 0.002 | 0.005 | 0.002 | 0.003 | 0.001 |
| 6 | 0.001 | 0.004 | 0.005 | 0.001 | 0.001 | 0.001 |
| 7 | 0.002 | 0.005 | 0.002 | 0.001 | 0.002 | 0.002 |
| 8 | 0.003 | 0.001 | 0.002 | 0.005 | 0.003 | 0.002 |
| 9 | 0.001 | 0.005 | 0.001 | 0.004 | 0.001 | 0.005 |
| 10 | 0.005 | 0.003 | 0.004 | 0.005 | 0.005 | 0.003 |
| 11 | 0.002 | 0.003 | 0.003 | 0.003 | 0.005 | 0.002 |
| 12 | 0.003 | 0.001 | 0.005 | 0.002 | 0.003 | 0.002 |
| 13 | 0.003 | 0.001 | 0.005 | 0.002 | 0.003 | 0.002 |
| 14 | 0.001 | 0.005 | 0.003 | 0.003 | 0.005 | 0.003 |
| 15 | 0.003 | 0.001 | 0.003 | 0.003 | 0.005 | 0.003 |
| 16 | 0.001 | 0.005 | 0.003 | 0.003 | 0.005 | 0.003 |
| 17 | 0.002 | 0.003 | 0.003 | 0.003 | 0.005 | 0.002 |
| 18 | 0.001 | 0.004 | 0.005 | 0.001 | 0.001 | 0.001 |
| 19 | 0.002 | 0.005 | 0.002 | 0.001 | 0.002 | 0.002 |

TABLE 3

| | Shot ball | Shot ball | | Number | Average |
|---|---|---|---|---|---|
| | projection | projection | Area fraction | fraction (%) | crystal grain |
| | amount | time | (%) of micro- | of micro- | particle |
| Remarks | (kg/min · m²) | (sec) | recrystallization | recrystallization | diameter (μm) |
| 1 | 25 | 55 | 25 | 55 | 13.1 |
| 2 | 30 | 50 | 30 | 50 | 9.6 |
| 3 | 35 | 45 | 35 | 45 | 8.3 |
| 4 | 31 | 35 | 31 | 35 | 12.5 |
| 5 | 29 | 30 | 29 | 30 | 6.9 |
| 6 | 27 | 25 | 27 | 25 | 7.9 |
| 7 | 25 | 20 | 25 | 20 | 9.4 |
| 8 | 23 | 15 | 23 | 15 | 6.7 |
| 9 | 20 | 60 | 20 | 60 | 23.8 |
| 10 | 19 | 5 | Not cold rollable | | |
| 11 | 17 | 3 | 17 | 3 | 0.4 |
| 12 | 15 | 1 | 15 | 1 | 0.2 |
| 13 | 18 | 4 | 18 | 4 | 0.3 |
| 14 | 24 | 12 | 14 | 12 | 0.3 |
| 15 | 11 | 28 | 11 | 28 | 0.3 |
| 16 | 38 | 32 | 38 | 32 | 16.7 |
| 17 | 40 | 36 | 40 | 36 | 18.9 |
| 18 | 30 | 0.5 | 30 | 0.5 | 0.7 |
| 19 | 25 | 70 | 20 | 70 | 14.8 |

TABLE 4

| | | | | | Magnetic | |
|---|---|---|---|---|---|---|
| | | | | | flux | Iron loss |
| | | | Equa- | Equa- | density | (W_{10/1000}, |
| Remarks | YP_{0.2R} | YP_{0.2C} | tion 1 | tion 2 | (B50, T) | W/kg) |
| 1 | 527 | 532 | 530 | 0.009443 | 1.67 | 65.4 |
| 2 | 573 | 585 | 579 | 0.020725 | 1.66 | 66.2 |
| 3 | 519 | 530 | 525 | 0.020972 | 1.66 | 70.3 |
| 4 | 591 | 602 | 597 | 0.018441 | 1.65 | 62.7 |
| 5 | 475 | 486 | 481 | 0.022893 | 1.67 | 69.8 |
| 6 | 534 | 545 | 540 | 0.020389 | 1.65 | 65.4 |
| 7 | 552 | 560 | 556 | 0.014388 | 1.65 | 63.8 |
| 8 | 622 | 623 | 623 | 0.001606 | 1.65 | 62.1 |
| 9 | 391 | 399 | 395 | 0.020253 | 1.65 | 81.2 |
| 10 | Not cold rollable | | | | | |
| 11 | 384 | 392 | 388 | 0.020619 | 1.64 | 85.4 |
| 12 | 421 | 427 | 424 | 0.014151 | 1.64 | 80.2 |
| 13 | 457 | 468 | 463 | 0.023784 | 1.66 | 77.6 |
| 14 | 468 | 472 | 470 | 0.008511 | 1.63 | 75.9 |
| 15 | 453 | 451 | 452 | 0.004425 | 1.65 | 83.1 |
| 16 | 499 | 517 | 508 | 0.035433 | 1.65 | 74.3 |
| 17 | 545 | 507 | 526 | 0.072243 | 1.64 | 83.2 |
| 18 | 554 | 568 | 561 | 0.024955 | 1.65 | 68 |
| 19 | 498 | 502 | 500 | 0.008 | 1.65 | 70.6 |

As shown in Tables 1 to 4, in the examples in which the alloy components and the shot ball projection amounts were appropriately adjusted, it was confirmed that micro-recrystallization was sufficiently secured, and strength was excellent and a variation in yield strengths in the rolling direction and the rolling vertical direction was small.

However, in the examples in which the alloy components were not appropriately adjusted, it was confirmed that micro-recrystallization was not appropriately formed, and the yield strength value was poor.

In addition, in the examples in which the shot ball projection amount was small, it was confirmed that the micro-recrystallization was not appropriately formed, and the yield strength value was poor.

In addition, in the examples in which the shot ball projection amount was excessive, it was confirmed that many micro-recrystallizations were formed, and the yield strength anisotropy was poor.

In addition, in the examples in which the shot ball projection time was too short or too long, it was confirmed that the yield strength and the magnetic properties were relatively poor as compared with Steel types 1 to 8.

The present disclosure is not limited by the above exemplary embodiments and may be manufactured in various forms different from each other, and it may be understood that a person with ordinary skill in the art to which the present disclosure pertains may carry out the present disclosure in another specific form without modifying the technical idea or essential feature of the present disclosure. Therefore, it should be understood that the exemplary embodiments described above are illustrative and are not restrictive in all aspects.

1. A non-oriented electrical steel sheet comprising, by weight: 2.0 to 6.5% of Si, 0.1 to 1.3% of Al, and 0.3 to 2.0% of Mn, with a remainder of Fe and unavoidable impurities,
wherein crystal grains having a particle diameter of 10% or less of a sheet thickness has an area fraction of 10.0% to 35.0% and a number fraction of 15% to 55%.

2. The non-oriented electrical steel sheet of claim 1, further comprising:
one or more of 0.2 wt % or less (excluding 0%) of Cr, 0.06 wt % or less (excluding 0%) of Sn, and 0.06 wt % or less (excluding 0%) of Sb.

3. The non-oriented electrical steel sheet of claim 1, further comprising: 0.005 wt % or less of one or more of C, N, S, Ti, Nb, and V.

4. The non-oriented electrical steel sheet of claim 1, further comprising:
one or more of 0.01 to 0.2 wt % of Cu, 0.100 wt % or less of P, 0.002 wt % or less of B, 0.01 wt % or less of Mo, 0.005 wt % or less of Mg, and 0.005 wt % or less of Zr.

5. The non-oriented electrical steel sheet of claim 1, wherein:
an average crystal grain particle diameter is 5 to 50 μm.

6. The non-oriented electrical steel sheet of claim 1, wherein:
a yield strength measured in a rolling direction and a yield strength measured in a rolling vertical direction satisfy the following Equation 1 and Equation 2:
(YP_{0.2R}+YP_{0.2C})/2≥480 Equation 1
YP_{0.2R}−YP_{0.2C}|/{(YP_{0.2R}+YP_{0.2C})/2}≤0.025 Equation 2
wherein YP_{0.2R} is a yield strength (MPa) measured in a rolling direction, and YP_{0.2C} is a yield strength (MPa) measured in a rolling vertical direction

7. The non-oriented electrical steel sheet of claim 1, wherein iron loss satisfies the following Equation 3:
W_{10/1000}≤40+t×240 Equation 3
wherein W_{10/1000} is iron loss (W/kg) when a magnetic flux density of 1.0 T is induced with a frequency of 1000 Hz, and t is a thickness (mm) of the steel sheet.

8. A method for manufacturing a non-oriented electrical steel sheet, the method comprising:
hot rolling a slab including, by weight: 2.0 to 6.5% of Si, 0.1 to 1.3% of Al, and 0.3 to 2.0% of Mn, with a remainder of Fe and unavoidable impurities, thereby manufacturing a hot rolled sheet;
removing scale present on a surface of the hot rolled sheet;
cold rolling the descaled hot rolled sheet to manufacture a cold rolled sheet; and
annealing the cold rolled sheet,
wherein the removing of scale is performed by projecting shot balls in an amount of 15 to 35 kg/(min·m²) onto the steel sheet.

9. The method for manufacturing a non-oriented electrical steel sheet of claim 8, wherein:
the shot balls have an average particle size of 0.1 to 1 mm, and are projected for 1 to 60 seconds.

10. The method for manufacturing a non-oriented electrical steel sheet of claim 8, wherein:
a material of shot balls is a Fe-based alloy.

11. The method for manufacturing a non-oriented electrical steel sheet of claim 8, wherein:
the annealing of the cold rolled sheet is performed at a temperature of 700 to 850° C.

12. The method for manufacturing a non-oriented electrical steel sheet of claim 8, further comprising:
annealing the hot rolled sheet, before the removing of scale.
